(19) United States
(12) Patent Application Publication
(10) Pub. No.: US 2003/0019020 A1
(43) Pub. Date: Jan. 30, 2003

(54) Anti-constipation method and device

(76) Inventors: Boris Reydel, Passaic, NJ (US); Anatoly Siyagine, New York, NY (US)

Correspondence Address: Breiner & Breiner, L.L.C., P.O. Box 19290, Alexandria, VA, 22320-0290, US

(21) Appl. No.: 09/915,296

(22) Filed: Jul. 27, 2001

(51) Int. Cl. E03D 11/00; G09B 9/00; G09B 19/00; A63B 69/00

(52) U.S. Cl. 4/254; 434/247

(57) ABSTRACT

A device and method for treatment of constipation wherein a horizontal bar is positioned a sufficient distance above a toilet that a person using the toilet can passively “semi-hang”. The act of passively “semi-hanging” partially removes weight from the perianal area and straightens the torso thereby unfolding the sigmoid colon, increasing the sigmoid-rectal angle and the anorectal angle to facilitate defecation.

### FIELD OF THE INVENTION

This invention relates to a method and device for treatment of constipation. More specifically, the invention provides for treatment of constipation caused by outlet obstruction by partially removing weight from the perianal area, unfolding the sigmoid-rectal angle, maintaining an open anorectal angle, increasing intra-abdominal pressure and relaxing the muscle of the pelvic floor and anal sphincters. The invention is accomplished by straightening a person's torso while the person passively “semi-hangs” from a bar stationed above a toilet.

### BACKGROUND OF THE INVENTION

Multiple internal structure-including the pelvic floor muscles, the extrinsic and intrinsic anal sphincters, the puborectalis and levator ani muscles, must act in a very coordinated fashion in order to sufficiently increase intra-abdominal pressure to expel fecal material. Also playing an important role in defecation are the anorectal angle in the anterior-posterior plane of the body and the acute angulation of the sigmoid part of the colon in the transverse plane of the body.

When the aforementioned structures are not optimally positioned within the body for defecating, the amount of straining and exertion required for complete expulsion of fecal matter is increased. The amount of exertion and straining needed to expel fecal matter is compounded when the person also suffers from constipation.

Constipation can include any number of symptoms such as infrequent stools, lack of urge, difficulty in passing stools, ineffective straining, incomplete evacuation, bloating and pain. Many people ignore these symptoms or treat themselves by dietary modifications or over-the-counter remedies.

The vast majority of constipated people have no obvious cause to explain their symptoms but are presumed to have an underlying disorder of colonic or anorectal motor function called idiopathic constipation. The precise categorization of distinct subtypes of idiopathic constipation is somewhat difficult because of variable definitions and methodology. Two major categories of idiopathic constipation are slow colonic transit and outlet obstruction.

In the slow colonic transit group, the entire length of the colon demonstrates slow propulsion, and the most common symptom is infrequent bowel movements and absence of the urge to defecate. In the outlet obstruction category, patients fail to propulse stool from the very distal portion of the colon called the rectum. Those patients may feel an urge to defecate, but when they sit on the toilet they cannot expel fecal material. They may strain excessively or sit for a long time, causing a frequent complication called hemorrhoids.

There are various conventional treatments available for managing constipation caused by slow colonic transit or outlet obstruction. The most common remedy is to increase fiber intake either by dietary changes or by consuming fiber supplements. Although bulk or fiber agents are usually benign, they are poorly tolerated by some persons due to bloating and poor taste. There are also multitudes of different laxatives that increase the volume of liquid content inside the lumen or that stimulate the motor function of the intestinal tract thereby facilitating defecation. Osmotic and stimulant laxatives however are not recommended on a daily basis because of the different side effects, including electrolyte imbalance, intrinsic nerve damage and possible addiction. Enemas can provide some relief of constipation, but they are also not recommended on a regular basis.

In addition to the remedies described above, a person can obtain relief from constipation by using mechanical devices to physically manipulate the body as a whole, or specific regions thereof. Specifically, for example, U.S. Pat. No. 2,534,664 to Gottlieb et al. discloses a rectum fitting for assisting in overcoming constipative conditions. The fitting is designed to be received within the crease between the cheeks of the rectum which is pressed or worked into place thereby causing flexing of the muscles and consequent expulsion of fecal matter. Additionally, Gottlieb et al. discloses an exercising framework to be located over the toilet for providing support while the fitting is being positioned for use.

Another example, U.S. Pat. No. 2,256,994 to Warshaw, discloses an apparatus for relieving constipation wherein a toilet seat is designed to straighten the anorectal angle so as to facilitate evacuation with only moderate straining. According to the Warshaw device, the anorectal angle is straightened by exterior manipulation of a portion of the body adjacent thereto by providing a toilet seat designed to effectuate the manipulation.

Additionally, U.S. Pat. No. 5,553,334 to Hillman describes a toilet structure for inducing a posture more conducive to facilitating bowel movements by providing for a curved toilet bowl having a detachable footrest for supporting the user's knees and upper legs. The result is that the user of the Hillman device is caused to be in a stooping position which lessens the strain on the user's back and colon thereby allowing the user to pass stool more easily.

The present invention introduces an additional mechanical alternative to the conventional treatments described above, as well as, an improvement over existing mechanical devices for treating constipation.

### OBJECTS AND SUMMARY OF THE INVENTION

Most toilet seats are low. Consequently, as shown at FIG. 1, when a person or user 10 sits on a conventional toilet 12, the user's buttocks 14 tend to sag below the level of the toilet seat 16. The lowness of the toilet seat 16 causes the user's feet 18 to be positioned somewhat behind the knees 20 and torso 22 of user 10 whereby user 10 leans forward with elbows 24 rested on or about knees 20. Consequently, the body takes on a compressed Z-shape as a whole. As shown at FIG. 2, in that position, the rectum 30 and sigmoid colon 32 are almost folded upon each other, and the sigmoid-rectal angle 34 and angulation of the sigmoid colon 36 create functional obstructions 38, 40 thereby slowing the downward movement of a fecal column.

Instead of squatting forward and forming the compressed Z-shape, the user can avoid the problems associated therewith by straightening his torso and leaning slightly backwards, moving his feet forward and knees slightly below the horizontal plane of the toilet seat so that his hips are slightly higher than the toilet seat thereby causing the angle between the sigmoid colon and rectum to increase and unfold. Thus, the functional obstructions caused by the sigmoid-rectal angle and angulation of the sigmoid colon and associated with using a conventional toilet in the conventional manner are lessened.

Further, when the user stretches his arms up as if grasping a chin-up bar high above the head, the abdominal cavity is heightened and narrowed, and the abdominal muscles tighten and increase intra-abdominal pressure to expel fecal material. Since the colon is loosely suspended lying mostly in the transverse plane, when the user stretches his arms upwardly, the colon is pulled up thereby untangling the sigmoid angulation in that plane and lessening the functional obstructions even further.

Additionally, when a bar is provided from which the user can passively “semi-hang” himself in a sitting position, excessive pressure from the perianal area is removed making it easier to coordinate straining down and the relaxation of the pelvic floor muscle as well as the external and internal anal sphincters.

It is evident that an apparatus and method are needed to effectively decrease functional obstruction of the colon associated with using conventional toilets. It is also evident that an apparatus and method are needed for removing pressure from the perianal area thereby coordinating straining downward with relaxation of the pelvic floor during defecation. Further, it is evident that an apparatus and method is needed combining the benefits of lessened functional obstruction of the colon with decreased perianal pressure.

Therefore, it is an object of this invention to provide an apparatus and method for treatment of constipation that can be used in conjunction with a conventional toilet.

A further object of this invention is to provide a method for treatment of constipation whereby the user of a conventional toilet straightens his back, slides his knees forward and down and raises both arms up as if grasping a hanging bar or the like above the head.

A further object of this invention is to provide a bar or the like suspended over a conventional toilet by any number of means from which a user of the toilet may passively “semi-hang”.

A further object of the present invention is to provide a bar from which a person may semi-hang supported by a pair of arms extending upward from a toilet lid or water tank.

A further object of this invention is to provide an apparatus and method for partially removing weight from the perianal area, partially unfolding the sigmoid-rectal angle, maintaining an open anorectal angle, increasing intra-abdominal pressure and relaxing the muscle of the pelvic floor and anal sphincters in order to facilitate expulsion of fecal material.

A further object of the present invention is to provide an apparatus and method for treating constipation having no side effects, such as those associated with dietary changes and taking supplements.

### BRIEF DESCRIPTION OF THE DRAWINGS

For a better understanding of the invention as well as other objects and features thereof, reference is made to the following detailed description of present embodiments and various alternatives thereto in connection with the accompanying drawings.

FIG. 1 is a partial cross-sectional side view of a person exhibiting a compressed Z-shape associated with using a conventional toilet in a conventional manner.

FIG. 2 is a front view of a person's colon exhibiting a compressed Z-shape in accordance with FIG. 1.

FIG. 3 is a side view of a person using a toilet in accordance with the present invention.

FIG. 4 is a front view of the person's colon of FIG. 3.

FIG. 5 is a perspective view of a four-legged, free-standing apparatus from which a person can passively “semi-hang” for treating constipation in accordance with the present invention.

FIG. 5a is a partial, cross-sectional side view of a sleeve as shown in FIG. 5.

FIG. 6 is a perspective view of a toilet with a lid in an open position having a bar in an extended position from which a person can passively “semi-hang” supported by the lid in accordance with an alternate embodiment of the present invention.

FIG. 7 is a perspective view of the toilet of FIG. 6 with the lid in a closed position and the bar in a recessed position.

FIG. 8 is a perspective view of a toilet having a bar from which a person can passively “semi-hang” supported by a water tank of the toilet in accordance with the present invention.

### DETAILED DESCRIPTION OF PRESENTLY PREFERRED EMBODIMENTS

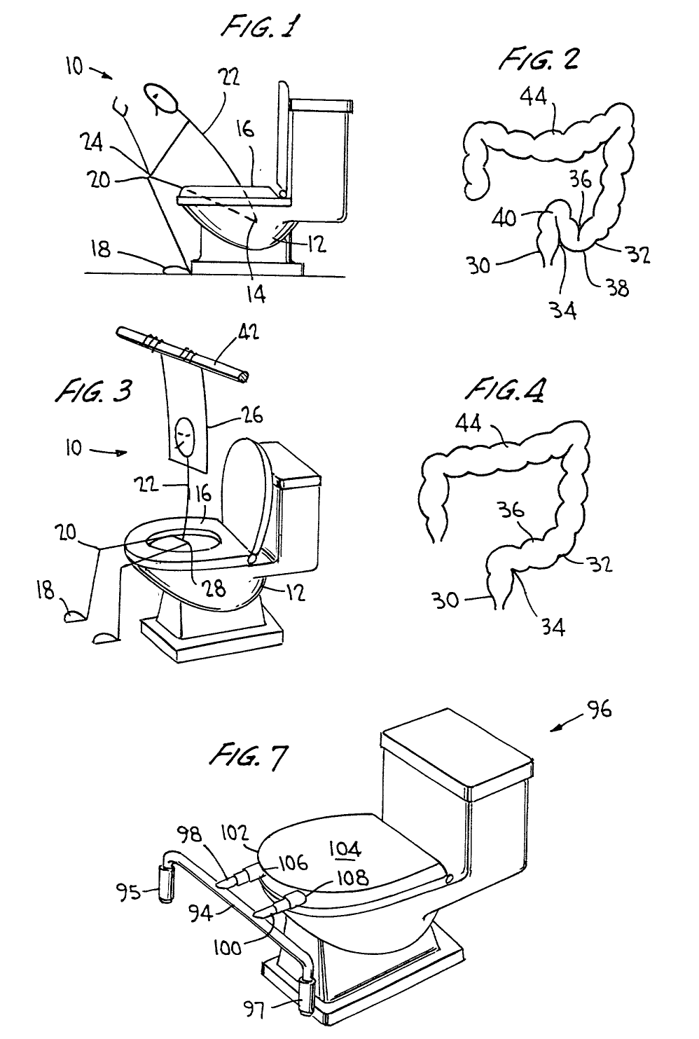

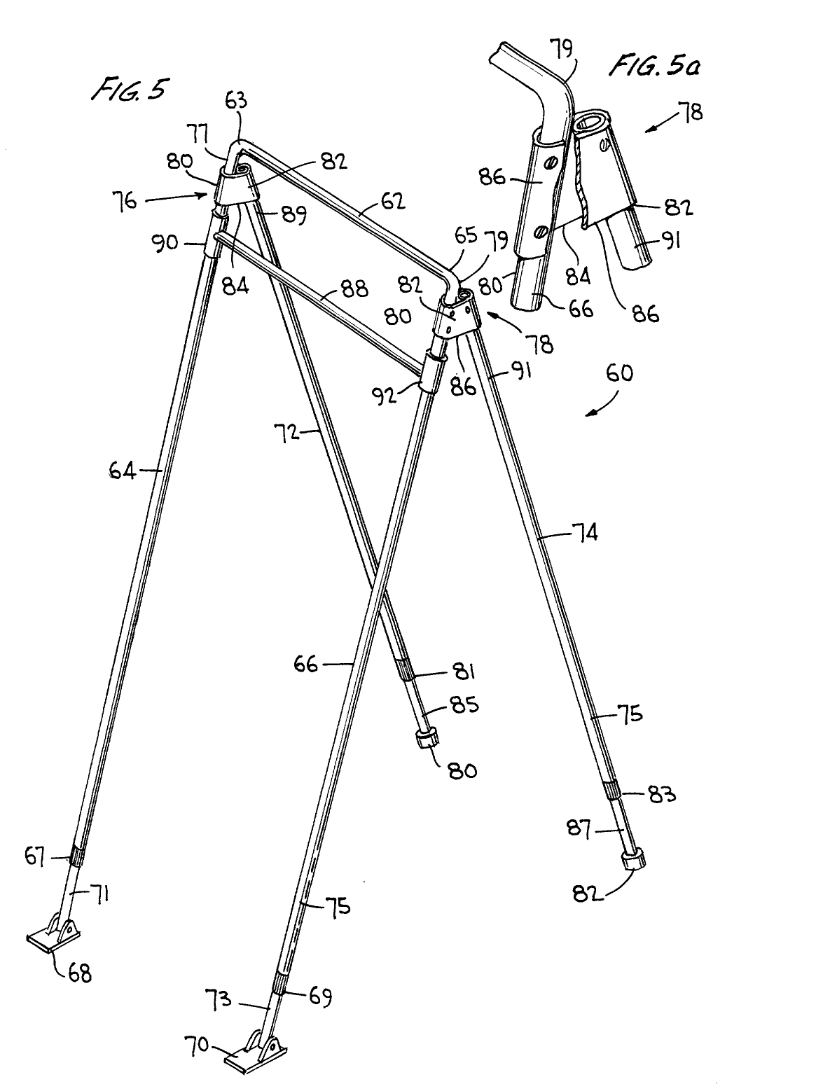

The preferred method of the present invention is illustrated at FIG. 3, where like portions share like numbering with FIG. 1, which is described above. A person's colon, as a person uses the preferred method, is illustrated at FIG. 4, where like portions share like numbering with FIG. 2, described above.

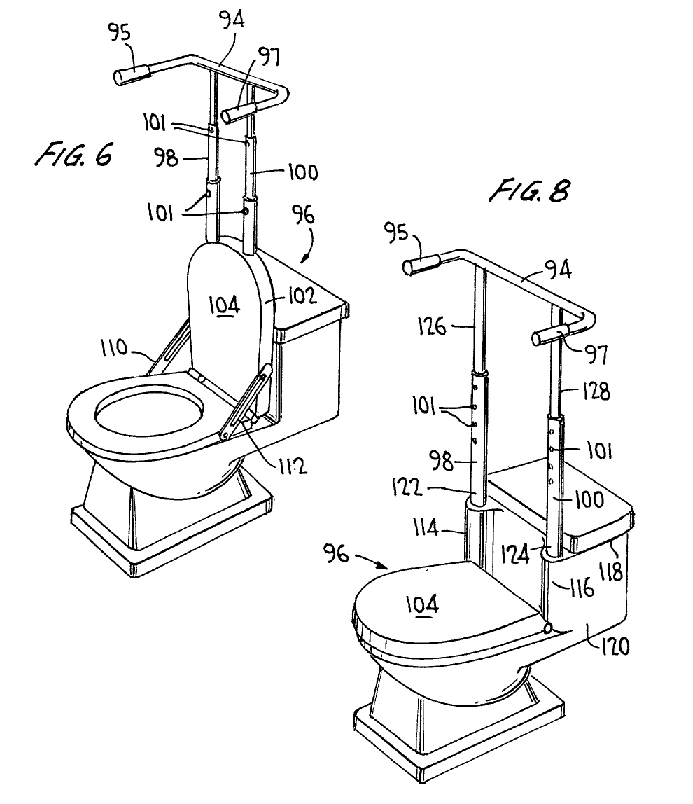

One embodiment of an apparatus of the present invention is shown in FIGS. 5 and 5a. An apparatus of alternative embodiments of the present invention is illustrated at FIGS. 6 and 7, where like portions share like numbering. An alternative to the apparatus illustrated at FIGS. 6 and 7 is illustrated at FIG. 8. FIG. 8 shares like numbering with like portions of FIGS. 6 and 7.

Generally, as shown in FIG. 3, the preferred method of the present invention allows a user 10 of a conventional toilet 12 suffering from constipation to facilitate the evacuation of a fecal column by extending a user's arms 26 upward, straightening a user's torso 22 and moving a user's feet 18 forward. As shown in FIG. 4, the external change in the user's posture causes the internal organs instrumental in the process of defecation to obtain an orientation conducive to moving a fecal column downward through the colon and rectum.

More particularly, a user 10 employing the preferred method of the present invention is positioned on a toilet 12 having a conventional seat 16. In order to orient user 10 for defecation, a user's torso 22 is straightened so that the user's torso 22 forms a right angle with the horizontal plane formed by seat 16. While keeping the torso 22 straight, the user 10 is caused to lean back slightly so that the user's torso 22 is no longer perpendicular to the plane formed by seat 16. Thereafter, a user's feet 18 are moved forward from the position illustrated in FIG. 1 to a position illustrated at FIG. 3, causing a user's knees 20 to be dropped slightly below the plane formed by seat 16 and a user's hips 28 to be lifted slightly above the plane formed by seat 16.

By straightening the user's torso 22, leaning the user's torso 22 slightly backward and moving the user's feet 18 forward, a user's sigmoid-rectal angle 34 formed between a user's sigmoid colon 32 and a user's rectum 30, as well as the angulation 36 of the sigmoid colon, shown at FIG. 1, is maximized. Consequently, the compressed Z-shape of the colon and rectum associated with the conventional method is released. More particularly, the user's sigmoid colon 32 is partially unfolded, thereby removing the obstruction 38 illustrated in FIG. 2. Further, the user's sigmoid colon 32 and rectum 30 are partially unfolded causing the sigmoid-rectal angle 34 to be relaxed thereby removing the functional obstruction 40 illustrated in FIG. 2.

To further facilitate evacuation of a fecal column, a user's arms 26 are extended upward as if the user 10 were reaching for a horizontal bar 42 positioned high above the toilet 12. By reaching upward, a user's diaphragm is lifted upward and a user's abdominal cavity is lengthened. The lengthening of the abdominal cavity causes a user's transverse colon 44 and, in turn, the user's sigmoid colon 32 to be pulled further upward and forward thereby further untangling the sigmoid angulation 36 and sigmoid-rectal angle 34. Further, by reaching upward, the abdominal muscles of the user tighten thereby increasing intra-abdominal pressure. Consequently, the user does not have to strain as much or have to spend as much time attempting to evacuate fecal material as would be necessary otherwise.

In addition to reaching upward, the user 10 can decrease the amount of time spent on the toilet 12 and degree of straining to void, if the user 10 passively “semi-hangs” above the toilet 12 from bar 42. Passively “semi-hanging” requires that the user 10 remove a small amount of body weight from the seat 16 of the toilet 12 without actively pulling up by bending elbows or tightening biceps and shoulders. It does not require the user 10 to remove all or a substantial amount of the user's body weight from the seat 16. By removing an amount of body weight from the seat 16, the amount of pressure in the perianal area can be decreased making it easier to coordinate straining down and further by relaxing the pelvic floor muscles and external and internal anal sphincters.

A four legged, free standing apparatus 60 from which a user can passively “semi-hang” is shown at FIG. 5. Generally, the free-standing apparatus 60 forms an A-frame shaped structure having a continuous, tubular metal front portion adapted to support a horizontal bar from which a user may passively “semi-hang” and a disjointed, tubular metal rear portion in accordance with the preferred method of the present invention.

More particularly, the front portion includes a suspended cross bar 62 having attached at an end 63 thereof a leg 64 and at an opposite end 65 a leg 66. Each leg 64, 66 extends downwardly at a right angle from the cross-bar 62 and terminates at a free lower end 67, 69. Extending downward out from each end 67, 69 of each respective leg 64, 66 is an adjustable lower portion 71, 73 having an outer diameter less than the inner diameter of the legs 64, 66. Foot-pieces 68, 70 are hingedly fastened to the lower end of each lower portion 71, 73 to ensure the secure placement of the front portion to a surface, such as a bathroom floor. The lower portions 71, 73 extend a specified length from ends 67, 69 and are maintained at the length using a conventional ball and detent mechanism 75, or any other suitable means.

The disjointed rear portion includes a pair of support members 72, 74 each hingedly attached to a respective upper end 77, 79 of a respective leg 64, 66 by way of a pair of sleeves 76, 78. Extending downward out from a lower end 81, 83 of each support member 72, 74, is an adjustable lower portion 85, 87 having an outer diameter less than the inner diameter of support members 72, 74. The lower portions 85, 87 extend a specified length from ends 81, 83 and are maintained at the length using a conventional ball and detent mechanism 75, or any other suitable means. A rubber or plastic footing 80, 82, having a suction cup or the like formed therein, is rigidly attached to a lower end of each of the lower portions 85, 87 to ensure secure contact of the rear portion with the floor. Although the preferred embodiment shown a FIG. 5 has a disjointed rear portion, support members 72, 74 can be constructed of a continuous, tubular metal rear portion having a cross-bar, similar to cross-bar 62 of the front portion. The cross-bars would abut in use.

As shown in FIG. 5a, each sleeve 76, 78 includes a cylinder 80 through which a respective leg 64, 66 is inserted and a pathway 82 adjacent thereto adapted to receive an upper end 89, 91 of a respective support member 72, 74. Cylinder 80 and pathway 82 are connected by opposing sidewalls 84, 86, which define pathway 82. Each sleeve 76, 78 is positioned near the upper end 77, 79 of a respective leg 64, 66 and rigidly fastened to the respective leg 77, 79 by any suitable means, such as by a nut and bolt or the like. Each supported member 72, 74 is inserted into a respective pathway 82 so that a portion of the upper end 89, 91 of each support member 72, 74 is covered by a respective sleeve 76, 78.

Each support member 72, 74 is hingedly attached to a respective sleeve 76, 78 so that the support members 72, 74 can travel within the pathway 82 defined by the opposing sidewalls 84, 86. Forward motion, in the direction of the front portion, of each support member 72, 74 is limited by the presence of a respective leg 64, 66. Rearward motion of each support member 72, 74 is limited by the pathway 82. Lateral movement of the support members 72, 74 is limited by opposing side walls 84, 86.

A horizontal bar 88 from which a person can passively “semi-hang” in accordance with the preferred method of the present invention is extended across the front portion parallel to the cross-bar 62 and attached at each end thereof to a respective leg 64, 66. More particularly, attached at each end of the horizontal bar 88 is a section 90, 92 of tubular metal having an inner diameter greater than the outer diameter of the legs 64, 66. The horizontal bar 88 is mounted on the front portion by inserting the legs 64, 66 through a respective section 90, 92 and sliding the horizontal bar 88 a sufficient distance above a toilet to allow a person using the toilet to passively “semi-hang” therefrom. The horizontal bar 88 can be adjustably fastened to the front portion using a conventional ball and detent mechanism or by using a pin structure wherein a pin is inserted through a pair of aligned pre-drilled holes in sections 90, 92 and through a pair of aligned pre-drilled holes in legs 64, 66.

The distance of horizontal bar 88 from a toilet can be adjusted by moving the bar 88 upward or downward along the legs 64, 66 of the front portion. Alternatively, the height of the horizontal bar 88 can be adjusted by increasing or decreasing the length of the legs 64, 66 and support members 72, 74 using lower portions 71, 73 and lower portions 85, 87 respectively.

In use, apparatus 60 is stationed about a toilet in an open position, as illustrated at FIG. 5, so that horizontal bar 88 is positioned above a toilet seat. Footings 80, 82 are pressed against a surface on which the apparatus 60 rests thereby securing the apparatus to the surface by suction. After the apparatus 60 is used, apparatus 60 can be moved from an open position to a closed position wherein legs 64, 66 are moved toward support members 72, 74. The folding of legs 64, 66 against support members 72, 74 can occur because of the hinged attachment of support members 72, 74 to sleeves 76, 78. In the closed position, footings 80, 82 stay secured to the surface, and the apparatus 60 is allowed to lean against a wall, or the like, behind the toilet.

Alternatively, as shown at FIGS. 6, 7 and 8, a horizontal bar from which a user can passively “semi-hang” in accordance with the preferred method of the present invention can be supported by a structure which extends from and is supported by a toilet.

More particularly, as shown at FIGS. 6 and 7, a horizontal bar 94 having at each end thereof a forwardly bent handle 95, 97 is suspended above a toilet 96 a sufficient distance to allow a person to passively “semi-hang” therefrom in accordance with the preferred method of the present invention. The horizontal bar 94 is supported by a pair of sectional parallel arms, 98, 100 which telescope upward from the outer edge 102 of a lid 104 of toilet 96 to attach to the horizontal bar 94.

As shown in FIG. 7, when the toilet 96 is not in use, the lid 104 is closed and the arms 98, 100 are telescoped inward toward the lid 104. A portion of the arms 98, 100 are received in recesses 106, 108 located within the lid 104. The recesses 106, 108 allow arms 98, 100 to be contained within the lid 104 and not projecting outward therefrom in an area surrounding the toilet 96. As shown in FIG. 6, in use, the lid 104 is opened and releasably locked in an open position using braces 110, 112. Braces 110, 112 can be any suitable brace which can be releasably locked in an open position. The arms 98, 100 are telescoped upward away from the outer edge 102 of the lid 104 so that the horizontal bar 94 is a sufficient distance above the toilet 96 that a person can passively “semi-hang” from the horizontal bar 94. To secure the arms 98, 100 upward, a conventional ball and detent mechanism 101 is used, or any other suitable means such as a pin structure inserted through pre-drilled holes in arms 98, 100.

Alternatively, rather than extending the arms 98, 100 from the lid 104, the arms 98, 100 can extend upward from a water tank 120 of the toilet 96. As shown at FIG. 8, the arms 98, 100 can extend upward from a pair of platforms 114, 116 which protrude from the upper edge 118 of the front of a water tank 120 of toilet 96. More particularly, the arms 98, 100 each include a lower portion 122, 124 rigidly attached at one end to the platforms 114, 116 and an upper portion 126, 128 having an outer diameter less than the inner diameter of the lower portions 122, 124. Upper portions 126, 128 extend upward out from lower portion 122, 124 to support the horizontal bar 94 at right angles a sufficient distance above toilet 96 that a person can passively “semi-hang” therefrom. The height of the horizontal bar 94 is adjusted by moving the upper portions 126, 128 upward or downward as they ride within lower portions 122, 124. The upper portions 126, 128 are secured at a particular height using a conventional ball and detent mechanism 101, or any other suitable means as described above.

Although the preferred embodiments illustrated in FIGS. 6, 7 and 8 have arms 98, 100, the apparatus exhibited therein can have one arm of sufficient structural strength for supporting horizontal bar 94.

As will be apparent to one skilled in the art, various modifications can be made within the scope of the aforesaid description. Such modifications being within the ability of one skilled in the art form a part of the present invention and are embraced by the appended claims.

It is claimed:

1. An apparatus for treatment of constipation comprising a substantially horizontal bar supported by a suspension means and suspended a sufficient distance above a toilet to allow a person using said toilet to passively semi-hang from said bar.

2. An apparatus in accordance claim 1 wherein said suspension means is a free-standing base having four downwardly extending legs.

3. An apparatus in accordance with claim 2 wherein said base comprises
a cross-bar having attached at a substantially right angle to each end thereof a downwardly extending leg, each said leg having a lower end constructed and arranged for contacting and positioning on a surface, and
a downwardly extending support member attached to an upper end of each said leg by a sleeve, each said support member having a lower end adapted to contact said surface,
wherein each said leg together is said suspension means.

4. An apparatus in accordance with claim 3 wherein said horizontal bar includes at each end thereof a section of pipe attached at a right angle to said horizontal bar, each said section of pipe adapted to slidably circumpose a respective said leg.

5. An apparatus in accordance with claim 3 wherein the length of each said leg and each said support member is adjustable.

6. An apparatus in accordance with claim 3 wherein each said sleeve comprises a pathway for receiving an upper end of a respective said support member and a cylinder adjacent thereto for receiving an upper end of a respective said leg,
wherein said support member is hingedly affixed to said sleeve.

7. An apparatus in accordance with claims 5 wherein said lower end of each said support member includes a suction cup for securing each said support member to a surface.

8. An apparatus in accordance with claim 3 wherein said lower end of each said leg comprises a non-skid foot hingedly attached thereto.

9. An apparatus for treatment of constipation comprising:
a cross-bar having attached at a substantially right angle to each end thereof a downwardly extending leg,
a downwardly extending support member hingedly attached to an upper end of each said leg, and
a horizontal bar connected at each end thereof to a respective said leg, said horizontal bar supported a sufficient distance above a toilet to allow a person using said toilet to passively semi-hang from said cross-bar.

10. An apparatus in accordance with claim 9 wherein said horizontal bar includes at each end thereof a section of pipe attached at a right angle to said horizontal bar, each said section of pipe adapted to slidably circumpose a respective said leg.

11. An apparatus in accordance with claim 9 wherein the length of each said leg and each said support member is adjustable.

12. An apparatus for treatment of constipation comprising:
at least one arm extending upward from a toilet, and
a horizontal bar supported by said at least one arm,
wherein said horizontal bar is a sufficient distance above said toilet to allow a person using said toilet to passively semi-hang from said horizontal bar.

13. An apparatus in accordance with claim 12 wherein said at least one arm has a means of adjusting the length of said at least one arm.

14. An apparatus in accordance with claim 13 wherein said at least one arm extends from a lid of said toilet.

15. An apparatus in accordance with claim 13 wherein said at least one arm extends from a water tank of said toilet.

16. An apparatus in accordance with claim 14 wherein said toilet includes at least one brace for releasably securing said lid in an open position.

17. An apparatus in accordance with claim 12 wherein said horizontal member includes handles.

18. An apparatus in accordance with claim 15 wherein said water basin includes a recess for receiving said at least one arm when said at least one arm is retracted into said water tank.

19. An apparatus in accordance with claim 14 wherein said lid includes a recess for receiving said at least one arm when said at least one arm is retracted into said lid.

20. A method of treating constipation comprising steps:
positioning a person on a seat of a toilet,
straightening a person's torso,
slightly reclining said person's torso toward a water tank of said toilet, and
positioning a person's feet on a surface a sufficient distance in front of said toilet so that said person's hips are positioned above said toilet seat.

21. A method of treating constipation in accordance with claim 20 wherein a person's arms are extended upward.

22. A method of treating constipation in accordance with claim 21 wherein said person passively semi-hangs from a bar.
